(19) United States
(12) Patent Application Publication
(10) Pub. No.: US 2026/0155721 A1
(43) Pub. Date: Jun. 4, 2026

(54) Vibration Motor

(71) Applicant: AAC Microtech (Changzhou) Co., Ltd., Changzhou City (CN)

(72) Inventors: Xixi Zou, Changzhou (CN); Hongmei Yan, Changzhou (CN); Xia Zheng, Changzhou (CN)

(21) Appl. No.: 19/036,058

(22) Filed: Jan. 24, 2025

Related U.S. Application Data
(63) Continuation of application No. PCT/CN2024/136488, filed on Dec. 3, 2024.

(51) Int. Cl. H02K 33/18

(52) U.S. Cl. CPC H02K 33/18

(57) ABSTRACT

The present invention provides a vibration motor includes a stator, an elastic member, and a vibrator. The stator includes a housing and a winding assembly. The winding assembly is arranged around a first direction. An end portion of the vibrator in the first direction is connected to the housing through the elastic member. The vibrator includes a first pole plate, a second pole plate, two magnets between the first and second pole plates, and a third pole plate arranged between two magnets. Each magnet is magnetized along the first direction, and the magnetization directions of the two magnets are opposite. The vibrator is at least partially surrounded within the winding assembly. The vibration motor of present invention has a simple structure, is easy to assemble, and has a small volume with high space utilization. The vibration motor can provide great vibration sensation in a small volume.

### FIELD OF THE PRESENT INVENTION

The present invention relates to the field of vibration devices, and more particularly, to a vibration motor.

### DESCRIPTION OF RELATED ART

In related art, the most common vibration device is the X-axis linear motor. The X-axis linear motor not only has a large volume, but also has a complex structure, which leads to cumbersome assembly and high cost. It is difficult to apply in some situations where both cost and performance are required.

Therefore, it is desired to provide a new vibration motor which can overcome the above problems.

### SUMMARY

In view of the above, the embodiments of the present invention provide a new vibration motor that solves the technical problems of large volume, complex structure, and cumbersome assembly of vibration devices in related art.

The present invention provides a vibration motor includes a stator, at least one elastic member, and a vibrator. The stator includes a housing having a receiving room and at least one winding assembly received in the receiving room. The winding assembly is arranged around a first direction and fixed to the housing. An end portion of the vibrator in the first direction is connected to the housing through the elastic member. The vibrator is suspended in the receiving room. The vibrator includes a first pole plate, a second pole plate spaced apart from the first pole plate along the first direction, at least two magnets located between the first pole plate and the second pole plate along the first direction, and at least one third pole plate arranged between the two magnets. Each magnet is magnetized along the first direction, and the magnetization directions of the two magnets are opposite. The vibrator is at least partially surrounded within the winding assembly.

As an improvement, the vibration motor includes two elastic members with a first elastic member and a second elastic member, the first elastic member fixed to one end of the housing along the first direction and connected to one end of the vibrator, and the second elastic member fixed to the other end of the housing along the first direction and connected to the other end of the vibrator.

As an improvement, the stator includes a plurality of winding assemblies arranged in sequence along the first direction, the winding assemblies arranged coaxially, current directions of the adjacent winding assemblies being opposite.

As an improvement, a number of third pole plates is the same as the number of winding assemblies, and each winding assembly is wound around the corresponding third pole plate.

As an improvement, the housing is a hollow structure with a first opening and a second opening, the first opening and the second opening arranged opposite to each other in the first direction, a hollow part of the housing designed as the receiving room; the first elastic member is set corresponding to the first opening, both ends of the first elastic member fixed to the housing, and a middle of the first elastic member fixed to the first pole plate; the second elastic member is set corresponding to the second opening, both ends of the second elastic member fixed to the housing, and the middle of the second elastic member fixed to the second pole plate.

As an improvement, the first elastic member is provided with at least one first hole, and the first pole plate includes a first body and a first protrusion formed on the first body, the first protrusion inserted in and fixed to the first hole; the second elastic member is provided with at least one second hole, and the second pole plate includes a second body and a second protrusion formed on the second body, the second protrusion inserted in and fixed to the second hole.

As an improvement, the first elastic member is provided with two first holes, two first holes spaced apart from each other and two first holes symmetrically arranged in a length direction of the first elastic member, the first pole plate including two first protrusions, each first protrusion arranged in the corresponding the first hole; the second elastic member is provided with two second holes, two second holes spaced apart from each other and two second holes symmetrically arranged in the length direction of the second elastic member; the second pole plate including two second protrusions, each second protrusion arranged in the corresponding the second hole.

As an improvement, a length of the housing in a second direction is greater than the length of the housing in a third direction, the second direction being perpendicular to the third direction, and both the second direction and the third direction being perpendicular to the first direction; two ends of the first elastic member in the second direction are fixed at two ends of the housing in the second direction, and two ends of the second elastic member in the second direction are fixed at two ends of the housing in the second direction.

As an improvement, the housing is an integrated structure, or the housing is assembled from at least two housing parts.

### BRIEF DESCRIPTION OF THE DRAWINGS

Many aspects of the exemplary embodiments can be better understood with reference to the following drawing. The components in the drawing are not necessarily drawn to scale, the emphasis instead being placed upon clearly illustrating the principles of the present invention. Moreover, in the drawings, like reference numerals designate corresponding parts throughout the several views.

FIG. 1 is an illustrative isometric view of a vibration motor in accordance with one embodiment of the present invention.

FIG. 2 is an illustrative isometric view of the partial structures of the vibration motor shown in FIG. 1.

FIG. 3 is an exploded view of the vibration motor of FIG. 1.

FIG. 4 is an illustrative view of the stator of the vibration motor shown in FIG. 1.

FIG. 5 a top view of the vibration motor shown in FIG. 1.

FIG. 6 is an illustrative cross-sectional view of the vibration motor taken along line A-A of FIG. 5.

FIG. 7 is an illustrative view of another magnetization direction of the vibrator of the vibration motor shown in FIG. 1.

FIG. 8 is an exploded view of the housing with a first structure of the vibration motor of FIG. 1.

FIG. 9 is an exploded view of the housing with a second structure of the vibration motor of FIG. 1.

FIG. 10 is another illustrative isometric view of another vibration motor of the present invention.

FIG. 11 a top view of the vibration motor shown in FIG. 10.

FIG. 12 is an illustrative cross-sectional view of the vibration motor with the magnetization direction taken along line B-B of FIG. 11.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of the present invention more apparent, the present invention is described in further detail together with the figures and the embodiments. It should be understood the specific embodiments described hereby is only to explain the disclosure, not intended to limit the disclosure.

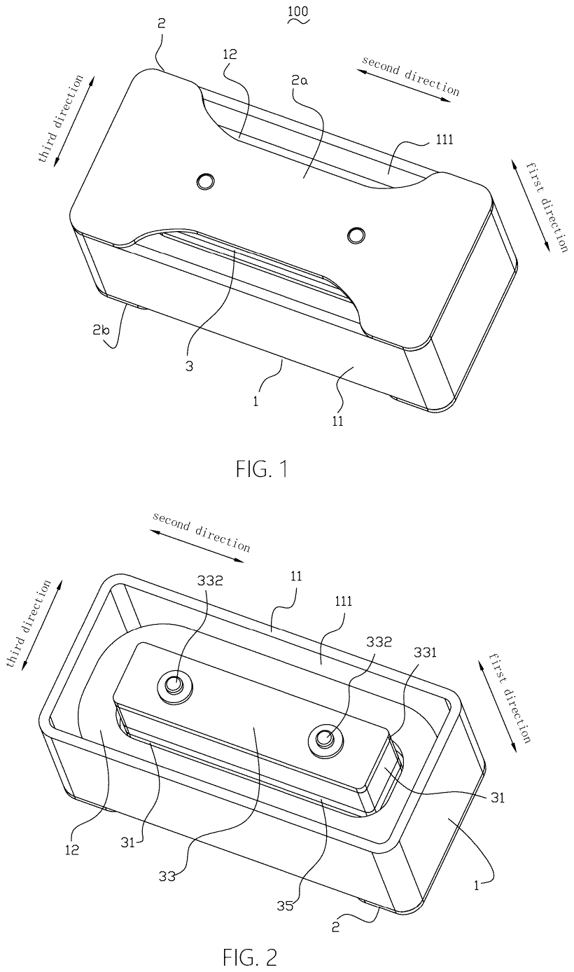

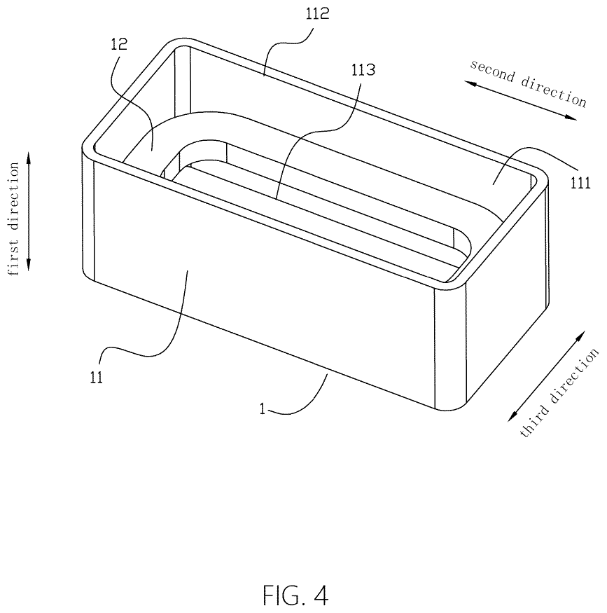

Referring to the FIGS. 1-6, the present invention provides one embodiment of a vibration motor 100. The vibration motor 100 includes a stator 1, at least one elastic member 2, and a vibrator 3. The stator 1 includes a housing 11 and at least one winding assembly 12. The housing 11 has a receiving room 111. The winding assembly 12 is received in the receiving room 111 and is fixed with the housing 11. The winding assembly 12 is arranged around a first direction. An end portion of the vibrator 3 in the first direction is connected to the housing 11 through the elastic member 2. The vibrator 3 is suspended in the receiving room 111. The vibrator 3 includes at least two magnets 31, a first pole plate 33, a second pole plate 34, at least one third pole plate 35. The second pole plate 34 is spaced apart from the first pole plate 33 along the first direction. All the magnets 31 are spaced apart from each other along the first direction. The magnets 31 locate between the first pole plate 33 and the second pole plate 34 along the first direction. Each magnet 31 is magnetized along the first direction, and the magnetization directions of the adjacent two magnets 31 are opposite. The third pole plate 35 is arranged between the two magnets 31. The vibrator 3 is at least partially surrounded within the winding assembly 12. Furthermore, there is a gap between the vibrator 3 and the winding assembly 12.

The vibration motor 100 of the embodiment of the present invention has a simple structure, low production cost, and a simple and easy assembly process. The present invention further reduces production requirements and production costs. The vibration motor of the embodiment of the present invention has a small volume and high space utilization, and can provide great vibration sensation in a small volume.

In the vibration motor of the present embodiment, when a periodic current is applied to the winding assembly 12, the stator 1 generates a periodic electromagnetic force on the vibrator 3. This electromagnetic force serves as an excitation source to drive the vibrator 3 to vibrate in the first direction. The vibration motor of the present invention has fast response and more realistic vibration sensation.

The vibration motor of the present embodiment can be applied to side keys, touch screens, vehicles, or other related fields.

As an example, the first direction can be in a Z direction, and the vibration motor in this embodiment of the present invention can be a Z-axis linear motor.

In some embodiments, the vibration motor includes two elastic members 2 with a first elastic member 2a and a second elastic member 2b. The first elastic member 2a is fixed to one end of the housing 11 along the first direction and is connected to one end of the vibrator 3, and the second elastic member 2b is fixed to the other end of the housing 11 along the first direction and is connected to the other end of the vibrator 3. In this way, the vibrator 3 can be reliably and effectively suspended in the receiving room 111.

In some embodiments, the winding assembly 12 can be bonded and fixed to the housing 11, or the winding assembly 12 can be fixedly connected to the housing 11 through other structures such as a supporting member, which can be set according to actual conditions and are not limited here.

In some embodiments, referring to the FIGS. 1-6, the stator 1 includes one winding assembly 12. Correspondingly, the vibrator 3 includes one first pole plate 33, one second pole plate 34, one third pole plate 35, and two magnets 31. The first pole plate 33, one of the magnets 31, the third pole plate 35, the other magnet 31, and the second pole plate 34 are sequentially arranged and fixedly connected along the first direction. The two magnets 31 are magnetized along the first direction, and the magnetization directions of the two magnets 31 are opposite. Please referring to FIG. 6, in this embodiment, the N poles of two magnets 31 are arranged facing to each other.

In this embodiment, the excitation schematic diagram of magnets 31 are shown in FIG. 6. Under the excitation action in the illustrated direction, the winding assembly 12 of stator 1 is subjected to ampere force, and the overall resultant force direction of stator 1 is downward, thereby causing the resultant force direction of the vibrator 3 to be upward. When a current in an opposite direction to the current shown in FIG. 6 is applied to the winding assembly 12, the direction of the resultant force acting on the vibrator 3 is downward. When the periodic current is applied to the winding assembly 12, the stator 1 will generate the periodic electromagnetic force on the vibrator 3. This electromagnetic force serves as the excitation source to drive the vibrator 3 to vibrate in the first direction. The vibration motor of the present invention has fast response and more realistic vibration sensation.

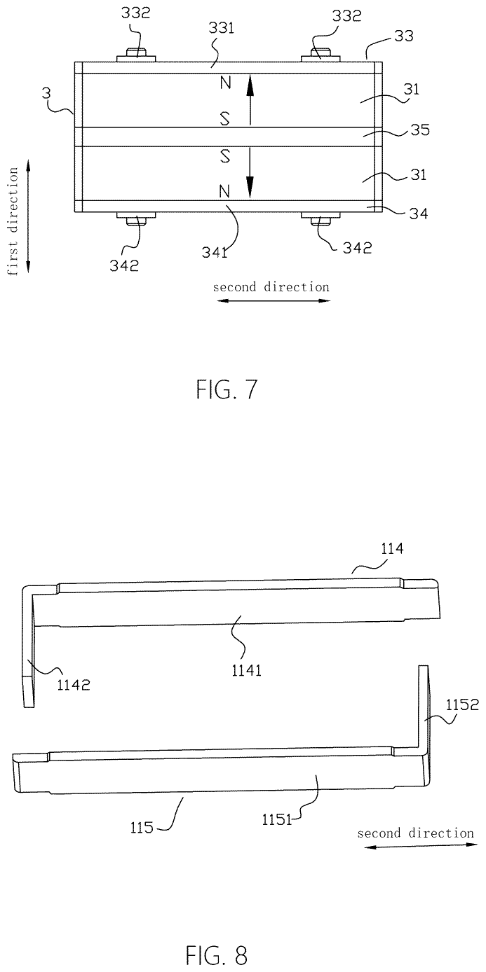

It should be noted that in other embodiments, please refer to FIG. 7. the S poles of the two magnets 31 can be set facing to each other. Which can be set according to actual conditions and are not limited here.

In some embodiments, referring to the FIGS. 10-12, the stator 1 may include a plurality of winding assemblies 12 arranged in sequence along the first direction, and the winding assemblies 12 are arranged coaxially. All the winding assemblies 12 are fixed to the housing 11. The current directions of the adjacent winding assemblies 12 are opposite.

Correspondingly, the vibrator 3 includes one first pole plate 33, one second pole plate 34, a plurality of third pole plates 35, and a plurality of magnets 31. There is one third pole plate 35 located between two adjacent magnets 31, and a number of the magnets 31 is one more than the number of the winding assemblies 12. The number of third pole plates 35 is the same as the number of winding assemblies 12. The third pole plate 35 and the winding assembly 12 are provided in one-to-one correspondence, and each winding assembly 12 is wound around the corresponding third pole plate 35.

As an optional embodiment, referring to the FIG. 12, the stator 1 may include two winding assemblies 12 spaced apart from each other in the first direction. The current directions of the winding assemblies 12 are opposite. The vibrator 3 includes one first pole plate 33, one second pole plate 34, two third pole plates 35, and three magnets 31. One third pole plate 35 is provided between two adjacent magnets 31. And each winding assembly 12 is wound around the corresponding third pole plate 35. All the magnets 31 are magnetized along the first direction, and the magnetization directions of the adjacent two magnets 31 are opposite.

It should be noted that in other embodiments, the stator 1 can include more winding assemblies 12, correspondingly increasing the number of third pole plates 35 and magnets 31 in vibrator 3, which can be set according to actual conditions and are not limited here.

In some optional embodiments, please referring to FIGS. 6 and 12, the housing 11 is a hollow structure with a first opening 112 and a second opening 113. The first opening 112 and the second opening 113 are arranged opposite to each other in the first direction. A hollow part of the housing 11 are designed as the receiving room 111. The first elastic member 2a is set corresponding to the first opening 112, and a middle of the first elastic member 2a is fixed to the first pole plate 33. Both ends of the first elastic member 2a are fixed to the housing 11. The second elastic member 2b is set corresponding to the second opening 113, and the middle of the second elastic member 2b are fixed to the second pole plate 34. Both ends of the second elastic member 2b are fixed to the housing 11. In this embodiment, the first elastic member 2a and the second elastic member 2b are respectively placed across the corresponding openings, which can reliably and effectively suspend the vibrator 3 in the receiving room 111.

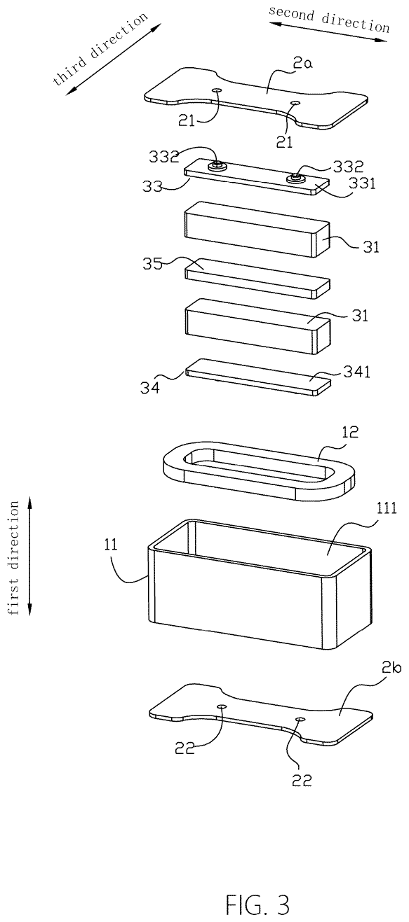

In some optional embodiments, please referring to FIG. 3, the first elastic member 2a is provided with at least one first hole 21, and the first pole plate 33 includes a first body 331 and a first protrusion 332 formed on a side of the first body 331 facing to the first elastic member 2a. The first protrusion 332 is inserted in and fixed to the first hole 21 to connect the first elastic member 2a and the vibrator 3. Similarly, please referring to FIG. 3, the second elastic member 2b is provided with at least one second hole 22, and the second pole plate 34 includes a second body 341 and a second protrusion 342 formed on a side of the second body 341 facing to the second elastic member 2b. The second protrusion 342 is inserted in and fixed to the second hole 22 to connect the second elastic member 2b and the vibrator 3. This embodiment not only has a simple structure, but also can quickly and accurately connect the elastic members 2 and the vibrator 3. The present invention further reduces assembly difficulty and improves product yield.

As an optional embodiment, please referring to FIG. 3, the first elastic member 2a is provided with two first holes 21, and two first holes 21 are spaced apart from each other and two first holes 21 are symmetrically arranged in a length direction of the first elastic member 2a. Correspondingly, the first pole plate 33 includes two first protrusions 332, each first protrusion 332 are arranged in the corresponding the first hole 21. And each first protrusion 332 is inserted in the corresponding the first hole 21. Similarly, please referring to FIG. 3, the second elastic member 2b is provided with two second holes 22, and two second hole 22 are spaced apart from each other and two second holes 22 are symmetrically arranged in the length direction of the second elastic member 2b. Correspondingly, the second pole plate 34 includes two second protrusions 342, each second protrusion 342 are arranged in the corresponding the second hole 22. And each second protrusion 342 is inserted in the corresponding the second hole 22. This embodiment can further improve the assembly accuracy between the first elastic member 2a and the vibrator 3, and the second elastic member 2b and the vibrator 3, thereby more stably and reliably suspending the vibrator 3 in the receiving room 111.

In some embodiments, the first protrusion 332 may be a stepped structure as shown in FIGS. 2, 3, 6, 7, and 12. It should be noted that in other embodiments, the first protrusion 332 may have a structure of other shapes. For example, the first protrusion 332 can be a cylinder, a square, or any other convex shape, which can be set according to the actual conditions and will not be repeated here. Similarly, the second protrusion 342 may be a stepped structure as shown in FIGS. 6, 7, and 12. It should be noted that in other embodiments, the second protrusion 342 may have a structure of other shapes. For example, the second protrusion 342 can be a cylinder, a square, or any other convex shape, which can be set according to the actual conditions and will not be repeated here.

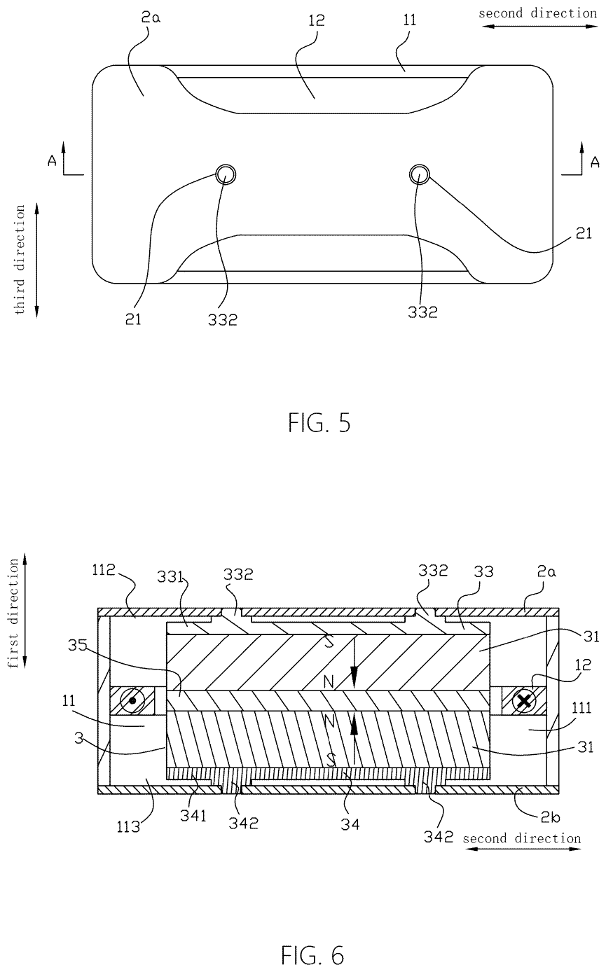

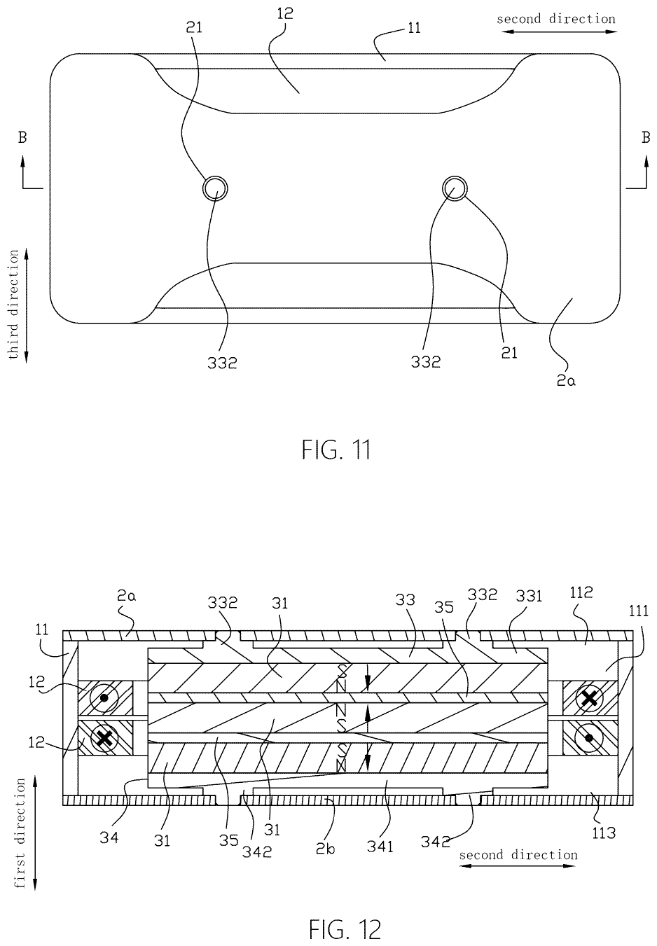

In some optional embodiments, please referring to FIGS. 5 and 11, a length of the housing 11 in a second direction is greater than the length of the housing 11 in a third direction. The second direction is perpendicular to the third direction, and both the second direction and the third direction are perpendicular to the first direction. The second direction is the length direction of the first elastic member 2a and the second elastic member 2b. Two ends of the first elastic member 2a in the second direction are fixed at two ends of the housing 11 in the second direction, and two ends of the second elastic member 2b in the second direction are fixed at two ends of the housing 11 in the second direction. In this way, it can effectively enhance the vibration sensation.

In some embodiments, please referring to FIG. 3, the housing 11 is an integrated structure. In this way, the assembly process of the vibration motor is further reduced, making it easier to assemble.

In some embodiments, please referring to FIG. 8, in order to facilitate the processing of the housing 11, the housing 11 can be a split structure. The housing 11 is assembled from at least two housing parts.

In some optional embodiments, the housing 11 can be formed by a first housing part 114 and a second housing part 115. The first housing part 114 and the second housing part 115 are symmetrically arranged about a central axis of the housing 11. The first housing part 114 includes a first plate 1141 and a second plate 1142, and the second plate 1142 is bent from one end of the first plate 1141. The second housing part 115 includes a third plate 1151 and a fourth plate 1152, and the fourth plate 1152 is bent from one end of the third plate 1151. The end of the first plate 1141 away from the second plate 1142 is fixed to the end of the fourth plate 1152 away from the third plate 1151, and the end of the second plate 1142 away from the first plate 1141 is fixed to the end of the third plate 1151 away from the fourth plate 1152, to form the receiving room 111.

As an example, the first plate 1141 and the fourth plate 1152 can be fixedly connected by welding or other methods, and the second plate 1142 and the third plate 1151 can be fixedly connected by welding or other methods.

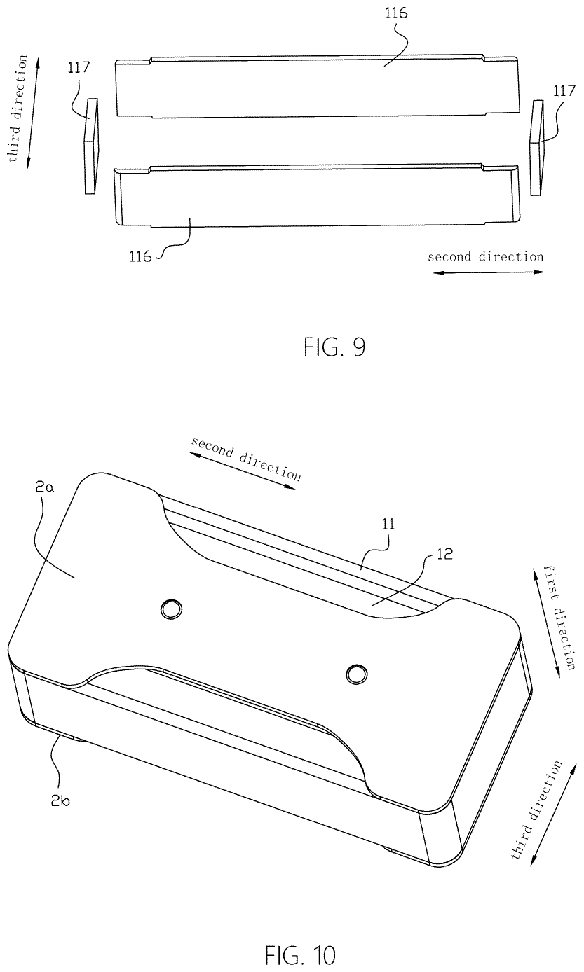

In an optional embodiment, please referring to FIG. 9, the housing 11 can be assembled from two third housing parts 116 and two fourth housing parts 117. Two third housing parts 116 are arranged parallel and spaced apart from each other, and two fourth housing parts 117 are arranged parallel and spaced apart from each other. The two third housing parts 116 are connected and fixed by the two fourth housing parts 117 to enclose the receiving room 111.

As an example, the third housing parts 116 and the fourth housing parts 117 can be fixedly connected by welding or other methods.

Comparing with the related art, the present invention provides a vibration motor includes a stator, at least one elastic member, and a vibrator. The stator includes a housing having a receiving room and at least one winding assembly received in the receiving room. The winding assembly is arranged around a first direction and fixed to the housing. An end portion of the vibrator in the first direction is connected to the housing through the elastic member. The vibrator is suspended in the receiving room. The vibrator includes a first pole plate, a second pole plate spaced apart from the first pole plate along the first direction, at least two magnets located between the first pole plate and the second pole plate along the first direction, and at least one third pole plate arranged between the two magnets. Each magnet is magnetized along the first direction, and the magnetization directions of the two magnets are opposite. The vibrator is at least partially surrounded within the winding assembly. The vibration motor of present invention has a simple structure, is easy to assemble, and has a small volume with high space utilization. The vibration motor can provide great vibration sensation in a small volume.

It is to be understood, however, that even though numerous characteristics and advantages of the present exemplary embodiments have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A vibration motor, comprising:
a stator comprising:
a housing having a receiving room; and
at least one winding assembly received in the receiving room, the winding assembly arranged around a first direction and fixed to the housing;
at least one elastic member; and
a vibrator, an end portion of the vibrator in the first direction connected to the housing through the elastic member, the vibrator suspended in the receiving room, the vibrator at least partially surrounded within the winding assembly, the vibrator comprising:
a first pole plate;
a second pole plate spaced apart from the first pole plate along the first direction;
at least two magnets located between the first pole plate and the second pole plate along the first direction, each magnet magnetized along the first direction, and magnetization directions of the two magnets being opposite; and
at least one third pole plate arranged between the two magnets.

2. The vibration motor as described in claim 1, wherein the vibration motor comprises two elastic members with a first elastic member and a second elastic member, the first elastic member fixed to one end of the housing along the first direction and connected to one end of the vibrator, and the second elastic member fixed to the other end of the housing along the first direction and connected to the other end of the vibrator.

3. The vibration motor as described in claim 2, wherein the stator comprises a plurality of winding assemblies arranged in sequence along the first direction, the winding assemblies arranged coaxially, current directions of the adjacent winding assemblies being opposite.

4. The vibration motor as described in claim 3, wherein a number of third pole plates is the same as the number of winding assemblies, and each winding assembly is wound around the corresponding third pole plate.

5. The vibration motor as described in claim 2, wherein the housing is a hollow structure with a first opening and a second opening, the first opening and the second opening arranged opposite to each other in the first direction, a hollow part of the housing designed as the receiving room;
the first elastic member is set corresponding to the first opening, both ends of the first elastic member fixed to the housing, and a middle of the first elastic member fixed to the first pole plate;
the second elastic member is set corresponding to the second opening, both ends of the second elastic member fixed to the housing, and the middle of the second elastic member fixed to the second pole plate.

6. The vibration motor as described in claim 5, wherein the first elastic member is provided with at least one first hole, and the first pole plate comprises a first body and a first protrusion formed on the first body, the first protrusion inserted in and fixed to the first hole;
the second elastic member is provided with at least one second hole, and the second pole plate comprises a second body and a second protrusion formed on the second body, the second protrusion inserted in and fixed to the second hole.

7. The vibration motor as described in claim 6, wherein the first elastic member is provided with two first holes, two first holes spaced apart from each other and two first holes symmetrically arranged in a length direction of the first elastic member, the first pole plate including two first protrusions, each first protrusion arranged in the corresponding the first hole;
the second elastic member is provided with two second holes, two second holes spaced apart from each other and two second holes symmetrically arranged in the length direction of the second elastic member; the second pole plate including two second protrusions, each second protrusion arranged in the corresponding the second hole.

8. The vibration motor as described in claim 5, wherein a length of the housing in a second direction is greater than the length of the housing in a third direction, the second direction being perpendicular to the third direction, and both the second direction and the third direction being perpendicular to the first direction;
two ends of the first elastic member in the second direction are fixed at two ends of the housing in the second direction, and two ends of the second elastic member in the second direction are fixed at two ends of the housing in the second direction.

9. The vibration motor as described in claim 1, wherein the housing is an integrated structure, or the housing is assembled from at least two housing parts.
